(19) United States
(12) Patent Application Publication
(10) Pub. No.: US 2010/0088477 A1
(43) Pub. Date: Apr. 8, 2010

(54) MEMORY SHARE SYSTEM AND MEMORY SHARE APPARATUS

(75) Inventor: Toshinori KATSUMATA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/635,056

(22) Filed: Dec. 10, 2009

Related U.S. Application Data
(63) Continuation of application No. PCT/JP2007/062933, filed on Jun. 27, 2007.

(51) Int. Cl. G06F 12/00

(52) U.S. Cl. 711/153; 711/E12.001

(57) ABSTRACT

Constructing to include a memory section and a share management section that divides a storage area of a storage apparatus attached to the memory section and allocates the divided areas to each plurality of information processing apparatus, thereby enabling sharing of the storage apparatus by the plurality of information processing apparatuses, carries out a memory access to the storage area on the basis of a memory access request signal from the each information processing apparatus, and generates a response signal from the memory section, thereby allowing the storage apparatus to function as an internal storage apparatus of the information processing apparatus, enables easy modification of the memory size used in an information processing apparatus by sharing memory which is provided external to the information processing apparatus among a plurality of information processing apparatuses, thereby facilitating effective use of the memory.

### CROSS-REFERENCE TO RELATED APPLICATION

This application is a continuation Application of a PCT international application No. PCT/JP2007/62933 filed on Jun. 27, 2007 in Japan, the entire contents of which are incorporated by reference.

### FIELD

The present invention related to a technique for sharing memory devices among a plurality of information processing apparatuses.

### BACKGROUND

Recent computers are configured such that memory devices (memory cards; internal storage apparatuses) are detachable on memory sockets provided on a mother board, thereby fulfilling the memory requirement for the computer to execute processing by a predetermined number of memory cards on these memory sockets. In other words, in the conventional architecture, memory devices (internal storage apparatuses) are provided on a computer basis.

In such conventional computers, for adding or removing memory cards, the memory cards should be removed physically after several procedures, such as powering off the computer, removing the enclosure.

The following Patent Reference 1 discloses a technique for extending or reducing memory devices by configuring such that memory devices are detachable using sockets and by inserting or removing the memory devices where necessary in a conventional memory extended system.

Patent Reference 1: Japanese Laid-Open Patent Publication No. H10-144070

However, in the conventional computer as described above, extension or removal of the memory cards may be cumbersome because several procedures, such as powering off the computer, removing the enclosure, are required.

In addition, for example, in computers that can run a plurality of systems (operating systems; OSs) on a single piece of hardware, such as server computers that are equipped with the partition (domain) functionalities, the above described procedures is required for modifying the memory capacity as a whole, although some systems are capable of dynamically changing the memory capacities allocated to respective systems.

Furthermore, in general, it is desirable that computers are configured by having enough size (memory capacity) of memory according to the applications of that system. However, the memory capacity may become insufficient afterward due to change of the applications or the like (memory shortage), which requires the above cumbersome procedure every time such shortage of the memory capacity is experienced.

In addition, for flexibly adjusting memory capacities among a plurality of computers, it is desirable that apart of memory cards on a computer having a sufficient memory capacity is moved to another computer experiencing such memory shortage. However, if the memory capacity on a single (a group of) memory card mounted on a computer is high, for example, removal of a single memory card may cause another memory shortage in the computer from which the memory card are removed. Thus, flexible adjustment of required memory may not be achieved, and new memory cards may be required, which is not cost-effective.

Furthermore, even when flexible adjustment of required memory is possible, insertion/removal of memory cards may be required every time temporally moving and returning memory cards among computers, which is cumbersome and time-consuming.

### SUMMARY

In order to achieve the above-identified object, a memory share system of the present invention is a memory share system including: a plurality of information processing apparatuses; and a sharing apparatus that is configured to be capable of communicating with each of the plurality of information processing apparatuses via a communication line, the sharing apparatus including: a memory section that is configured to be capable of attaching and detaching a storage apparatus; and a share management section that divides a storage area of the storage apparatus attached to the memory section and allocates the divided areas to each plurality of information processing apparatus, thereby enabling sharing of the storage apparatus by the plurality of information processing apparatuses, carries out a memory access to the storage area on the basis of a memory access request signal from the each information processing apparatus, and generates a response signal from the memory section, thereby allowing the storage apparatus to function as an internal storage apparatus of the information processing apparatus.

In addition, a memory share apparatus of the present invention is a sharing apparatus that is configured to be capable of communicating with a plurality of information processing apparatuses and each of the plurality of information processing apparatuses via communication lines, the sharing apparatus including: a memory section that is configured to be capable of attaching and detaching a storage apparatus; and a share management section that divides a storage area of the storage apparatus attached to the memory section and allocates the divided areas to each plurality of information processing apparatus, thereby enabling sharing of the storage apparatus by the plurality of information processing apparatuses, carries out a memory access to the storage area on the basis of a memory access request signal from the each information processing apparatus, and generates a response signal from the memory section, thereby allowing the storage apparatus to function as an internal storage apparatus of the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating a memory share system as one embodiment;

FIG. 2 is a diagram schematically illustrating a memory adaptor in the memory share system as one embodiment;

FIG. 3 is a diagram schematically illustrating an example of a management table in a memory share system as one embodiment;

FIG. 4 is a flowchart illustrating processing upon attaching to a memory adaptor in a computer to in the memory share system as one embodiment;

FIG. 5 is a flowchart illustrating processing upon initialization of the memory share apparatus in the memory share system as one embodiment;

FIG. 6 is a flow chart illustrating processing related to a memory access in the memory share system as one embodiment; and

FIG. 7 is a flow chart illustrating technique to release a memory or to change the memory size in the memory section in the memory share system as one embodiment.

### DESCRIPTION OF EMBODIMENTS

Hereinafter, embodiments will be described with reference to the drawings.

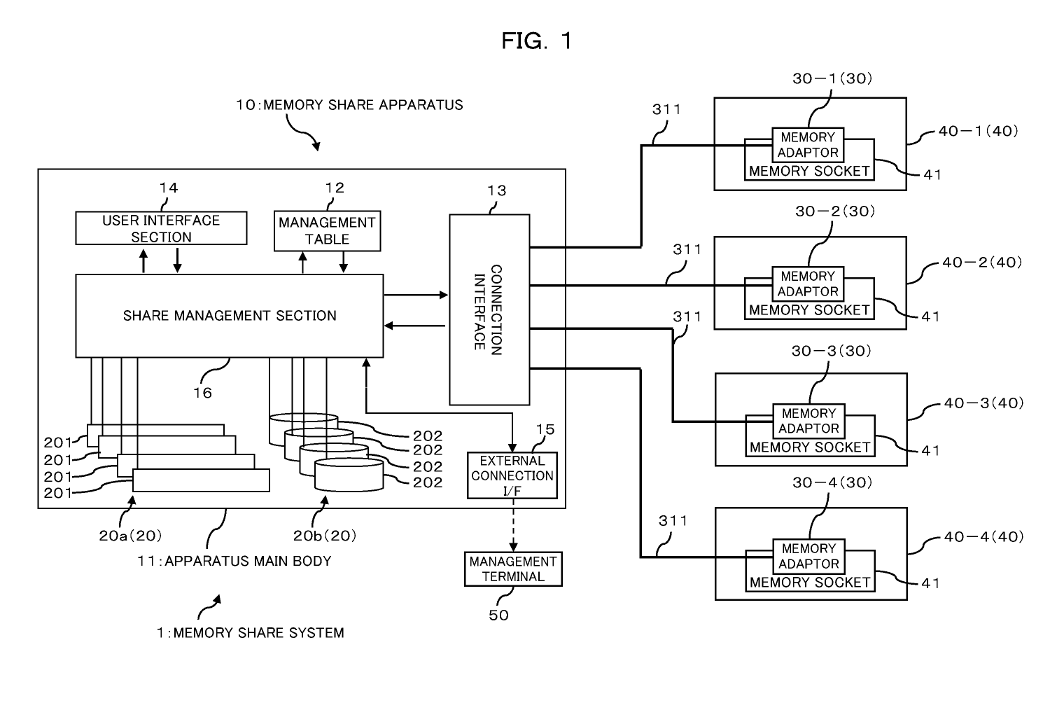

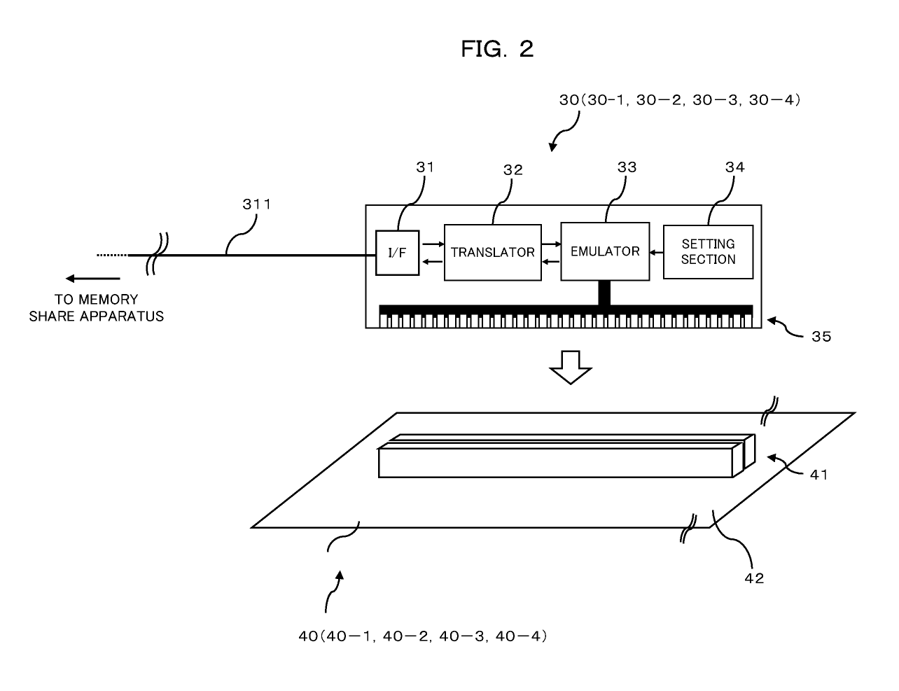

FIG. 1 is a diagram schematically illustrating the configuration of a memory share system 1 as one embodiment, and FIG. 2 is a diagram schematically illustrating the configuration of its memory adaptor.

The memory share system 1 is configured to include a memory share apparatus 10, and a plurality of (four, in the example depicted in FIG. 1) computers 40 (40-1, 40-2, 40-3, 40-4) that are connected to the memory share apparatus 10 via communication lines 311, as depicted in FIG. 1. The memory share system 1 enables storage apparatuses, such as memory devices 201 or hard disk drives (HDDs) to be shared among the plurality of computers (information processing apparatuses) 40, and allows these storage apparatuses to function as a internal storage apparatus of each of the computers 40.

Each of the computers 40-1, 40-2, 40-3, and 40-4 includes a central processing unit (CPU, not depicted), and is adapted to embody a variety of functionalities by executing a variety of operating systems (OS) and programs by the CPU. In the computers 40-1, 40-2, 40-3, and 40-4, for example, when the CPU executes an OS or a program, a variety of data and programs may be temporarily unfolded or stored in the internal storage apparatus (memory device, main memory, hereinafter, simply referred to as “memory”), and the CPU then accesses a certain region in the memory (memory access) to store (write) data or read programs or data stored thereon.

It is noted that the term “internal storage apparatus” refers to any storage apparatus with which the CPU can directly exchange data, and is configured as memory cards (memory modules, physical memory), such as single inline memory modules (SIMMs) or double inline memory module (DIMMs), for example.

In addition, in this embodiment, the computers 40-1, 40-2, 40-3, and 40-4 have the similar configurations, and hereinafter, as reference symbols for the computers, reference symbols 40-1 to 40-4 are used for identifying certain one of the plurality of computers while reference symbol 40 is used for any ones of the computers.

The computer 40 includes a mother board 42, as depicted in FIG. 2, and is configured to attach or detach the above-described memory card to and from a memory socket (attachment section) 41 provided on the mother board 42. It is noted that, in the example depicted in this figure, other modules, such as the CPU, mounted on the mother board 42, are omitted from the illustration for the brevity.

The memory card is a memory module, e.g., a SIMM or a DIMM, as described above, and is configured to include a memory chip and a terminal for electrically connect a memory chip to a memory bus (not depicted) provided on the mother board 42 of the computer 40, for example. By inserting and connecting the terminal to memory socket 41, in the computer 40, the memory chip is connected to the CPU via the memory bus or the like.

It is noted that the memory socket 41 may be embodied using a variety of well-known techniques, and may be practiced in many variations according the specification and standard of the memory card.

The memory share apparatus (sharing apparatus) 10 includes a storage apparatus that is configured to be capable of communicating with and be accessed from each of the above-described plurality of the computers 40, the plurality of the computers 40, and is configured to include the apparatus main body 11 and the plurality of (four, in the example depicted in FIG. 1) memory adaptor 30-1, 30-2, 30-3 and 30-4.

In the memory share system 1, each of the memory adaptors 30-1, 30-2, 30-3, and 30-4 is adapted to be attached to the corresponding memory socket 41 in place of a memory card as described above in the respective computer 40, as depicted in FIG. 1.

More specifically, in this embodiment, the memory adaptor 30-1 is adapted to be inserted and connected to the memory socket 41 of the computer 40-1; similarly, the memory adaptor 30-2 is adapted to be inserted and connected to the memory socket 41 of the computer 40-2, the memory adaptor 30-3 is adapted to be inserted and connected to the memory socket 41 of the computer 40-3, the memory adaptor 30-3 is adapted to be inserted and connected to the memory socket 41 of the computer 40-3.

The memory adaptors 30-1, 30-2, 30-3, and 30-4 have the similar configurations, hereinafter, as reference symbols for the computers, reference symbols 30-1 to 30-4 are used for identifying certain one of the plurality of memory adaptors while reference symbol 30 is used for any ones of the memory adaptors. The detail of the memory adaptor 30 will be explained below.

The memory adaptor 30 is configured to include an interface (I/F) 31, a translator (conversion section) 32, an emulator (memory access mediating section) 33, a setting section 34, and a terminal (connection section) 35, as depicted in FIG. 2, and is communicatively connected, via the communication line 311, to a connection interface 13 of the apparatus main body 11 which will be described later.

The terminal (connection section) 35 is adapted to communicatively connect the CPU to the emulator 33 when inserted into the memory socket 41 provided on the mother board 42 of the computer 40, and is configured according to the standard of the memory socket 41 e.g., a DIMM or SIMM, for example.

The emulator (memory access mediating section) 33 is adapted to obtain a memory access request signal from the computer 40 via the terminal 35 when the memory adaptor 30 is attached to the memory socket 41 of the computer 40 in place of a memory card (see FIG. 1), and is adapted to generate a memory access request signal to a memory section 20 of the apparatus main body 11 which will be described later on the basis of that memory access signal, and is further adapted to generate a response signal to the computer 40 on the basis of the response signal from the memory section 20.

The emulator 33 is adapted to generate an access request to the memory section 20 on the basis of a memory access request (for example, a read request or a write request) executed by the CPU in the computer 40, and responds to the CPU or the like which made the memory access request on the basis of a response signal from the memory section 20 which will be described later regarding to the memory access request according to the standard of the memory corresponding to the memory socket 41 to which the memory adaptor 30 is attached, for example.

The translator 32 is adapted to send the memory access signal generated by the emulator 33 to the connection interface 13 of the apparatus main body 11 via the interface 31 or the communication line 311, and is further adapted to function as a conversion section that converts between the protocol related to memory accesses in the computer 40 and the protocol related to memory accesses in the memory section 20 in the memory share apparatus 10.

More specifically, the translator 32 is adapted to, when the protocol related to memory accesses in the computer 40 and the protocol related to memory accesses in the memory section 20 in the memory share apparatus 10 are different, convert or adjust the timing of a memory access request signal from the computer 40 according to the protocol related to memory accesses in the memory section 20 in the memory share apparatus 10. In addition, the translator 32 is adapted to convert or adjust the timing of a response signal from received from the memory share management section 16 in the apparatus main body 11 via the connection interface 13, the communication line 311 and the interface 31 according to the protocol related to memory accesses in the computer 40.

For example, the computer 40 is configured to mount a SIMM memory in the memory socket 41 while a memory card 201 mounted on the memory section 20 in the apparatus main body 11 is a DIMM memory, the translator 32 enables memory accesses from the computer 40 to the memory section 20 by adjusting signal timing between the standard for SIMM and the standard for the DIMM and the like.

The interface (I/F) 31 is adapted to communicatively connect the memory adaptor 30 to the apparatus main body 11 via the communication line 311, and, is constructed by a connector, for example. Memory access signals that undergo processing, such as protocol conversion, by the translator 32, and response signals sent from the apparatus main body 11 via the communication line 311 are received or sent between the apparatus main body 11 and the memory adaptor 30 via the interface 31 or via the communication line 311.

It is noted that the communication line 311 is configured to be attachable to and detachable from the interface 31 to enable the communication line 311 to be connected to and disconnected from the interface 31 where necessary by the user, thereby improving convenience and increasing the versatility of the memory share system 1.

A setting section 34 is adapted to retain information on settings of operations of the memory share apparatus 1 or the like. The memory share apparatus 1 is adapted to enable the user to change the size of the memory area (memory size) of the memory section 20 where necessary which allocated to the computer 40 to which the memory adaptor 30 is attached, as described below. Furthermore, the memory share apparatus 1 is adapted to enable management of this memory size as a value set by the share management section 16 that will be described later (on the side of the apparatus main body 11) as well as allowing arbitral setting on the side of the memory adaptor 30, and further enables the user to select whether the setting value on the apparatus main body 11 side or the setting value on the memory adaptor 30 side is to be used.

The setting section 34 is adapted to beset or store information indicating whether the setting value on the apparatus main body 11 side or the setting value on the memory adaptor 30 side is to be used (enabled), and information indicating the setting value representative of the memory size when the setting value on the memory adaptor 30 side is enabled.

For example, the setting section 34 is constructed by dip switches or jumper switches or the like, and is adapted to be set arbitrally by the user by switching these switches. It is noted that the setting section 34 may set switch setting using software and the result may be stored on a non-volatile memories or the like, for example, rather than using hardware, such as dip switches or jumper switches, and the setting may be practiced in many variations without departing from the spirit of the present invention.

The share management section 16 that will be described later is adapted to carry out various operations, such as allocating the memory size to the computer 40 to which the memory adaptor 30 is attached, according to the setting value set in the setting section 34, as described below.

In addition, the memory size is essentially changed when the computer 40 is powered off. However, when the BIOS (Basic Input Output System) supports dynamic modification of the memory size of the computer 40 or the like, the memory size may be changed on the memory adaptor 30 even when the system on the computer 40 is running, or the required memory size may be monitored and dynamically changed on the memory share apparatus 10 on the basis of management software of a management terminal 50 or input operations from an user interface section 14.

The apparatus main body 11 is configured to include the user interface section 14, a management table 12, a connection interface (I/F) 13, a share management section 16, a memory section 20, and an external connection terminal 15, and is adapted to connected to the memory adaptor 30 via the communication line 311. The memory section 20 is configured to be able to attach or detach storage apparatuses, such as memory cards 201 or HDDs (hard disk drives) 202, and divide the storage areas of these storage apparatuses and allocate the divided areas to the plurality of the computers 40, thereby enabling sharing of the storage apparatuses among the plurality of the computers 40. The memory section 20 is configured to include a first memory section 20a and a second memory section 20b, in the example depicted in FIG. 1.

The first memory section 20a includes one or more memory cards (memory modules, physical memory) 201, such as SIMMs or DIMMs (four in the example depicted in FIG. 1), includes a plurality of memory sockets (not depicted) having the similar or the same configuration as that of the memory socket 41 of the computer 40, is adapted to detachably receive the memory cards 201 in the memory socket.

That is, the memory section 20a is adapted to receive the memory card 201 that is generally attached to the memory socket 41 of the computer and functions as an internal storage apparatus.

In addition, when the plurality of memory cards 201 are provided to the memory section 20a, the memory cards 201 are adapted to form a memory array.

Furthermore, the memory section 20a is able to attach and operate the memory cards 201 of a variety of types, and includes a memory socket for a SIMM and a memory socket for a DIMM, for example. The memory socket for a SIMM is provided with operating voltage for the SIMM (for example, 5 V) whereas the memory socket for a DIMM is provided with operating voltage for the SIMM (for example, 3.5 V).

The disk array 20b is adapted to include one or more HDDs (physical disks) 202 (four in the example depicted in FIG. 1), includes a plurality of sockets (interfaces; not depicted) for the IDE (Integrated Drive Electronics) or the ATA (Advanced Technology Attachment), for example, and is adapted to detachably receive an HDD 202 that is conform to the standard to a respective socket.

In addition, when the plurality of HDDs 202 are provided to the disk section 20b, the HDDs 202 are adapted to form a disk array.

Furthermore, the disk section 20b is able to attach and operate the HDDs 202 of a variety of standards, and includes a socket according to various standards, such as the above-described IDE (ATA) and the SCSI (Small Computer System Interface), for example. The disk section 20b is able to attach and operate the HDDs 202 of a variety of standards, such as the IDE (ATA) or the SCSI.

In addition, the memory section 20 is adapted to store information on the memory sizes allocated to each of the computers 40, and certain regions in the memory section 20 (first memory section 20a or second memory section 20b) store the memory sizes allocated to the computers 40 which are related to identification information for identifying each of the computers 40-1, 40-2, 40-3, and 40-4.

The share management section 16 enables the memory cards 201 or the HDD 202 to be shared among the plurality of the computers 40 and to function as respective internal storage apparatuses by carrying out access management to the storage areas in the memory section 20 on the basis of a memory access request from a computer 40 which is obtained via the memory adaptors 30-1, 30-2, 30-3, and 30-4 that will be described later or the communication line 311.

The share management section 16 is adapted to manage the memory cards 201 (physical memory) and the HDDs 202 (physical disks), and carry out allocation management of the memory (the memory cards 201 and the storage areas of the HDD 202) to the plurality of the computers 40 and access management (memory access management) on storage areas of the memory cards 201 and the HDDs 202 from the plurality of the computers 40.

More specifically, the share management section 16 is adapted to reserve a storage area having a certain size on the memory section 20 (memory array, disk array) on the basis of the setting value set to a setting section 34 of the memory adaptors 30-1, 30-2, 30-3, and 30-4 that will be described later, or the setting value that is predetermined and set to the memory section 20 or by the management terminal 50 that will be described later, and set a virtual address (hereinafter, sometimes referred to as “apparatus memory address”) by relating it to the address on the memory adaptor 30 (the address managed by the CPU in the computer 40; hereinafter, referred to as “computer memory address”).

It is noted that the relationship (mapping) between a computer memory address and an apparatus memory address is managed by the management table 12 that will be described later.

In addition, in this embodiment, the share management section 16 is adapted to manage the plurality of memory cards 201 (physical memory), the HDDs 202 (physical disks) that are mounted on the memory section 20, and storage devices similar to these as a single virtual memory (storage area).

It is noted that a single storage area that is formed by virtually grouping each storage area of the plurality of memory cards 201 and HDDs 202 provided to the memory section 20 may be referred to as a “memory array”. In addition, the technique for handling storage areas of a plurality of storage apparatuses as a single memory (memory array) may be achieved by using a variety of well-known techniques, and the detailed description of such techniques will be omitted.

The share management section 16 is adapted to reserve (allocate) a memory area (physical memory area) having a certain size to each of the computers 40 in each memory array, and virtually set a memory area having the same size as a memory area (virtual memory area; virtual storage area) on the memory adaptor 30 attached to each of the computers 40 corresponding to the physical memory area.

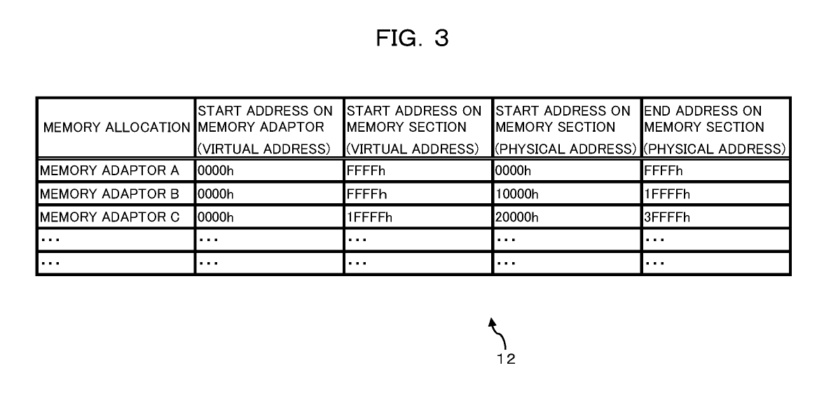

FIG. 3 is a diagram schematically illustrating an example of a management table 12 in the memory share system 1 as one embodiment.

The management table 12 represents physical memory areas in the memory section 20 and their relations to virtual memory areas (virtual storage areas). For each of the plurality of memory adaptors 30-1, 30-2, 30-3, and 30-4, the management table 12 is configured to relate the start address (physical address) and the end address (physical address) of a physical memory area allocated to the computer 40 to which the memory adaptor 30 is attached, to the start address (virtual address) and the end address (virtual address) of the virtual memory area that corresponds to that physical memory area.

In addition, in FIG. 3, the memory adaptor 30-1 is designated as “the memory adaptor A,” similarly the memory adaptor 30-2 is designated as “the memory adaptor B,” the memory adaptor 30-3 is designated as “the memory adaptor C,” and the memory adaptor 30-4 is designated as “the memory adaptor D.” In addition, in FIG. 3, the letter “h” affixed to each address represents the address is a hexadecimal number.

In the example depicted in FIG. 3, for example, a memory area (physical memory area) having a start address at the physical address 0000h and an end address at the physical address FFFFh in the memory section 20 is allocated to the memory adaptor A, and relates this to a memory area (virtual memory area) having a start address at the virtual address 0000h an end address at the virtual address FFFFh as its related virtual memory area.

Similarly, in the example depicted in FIG. 3, a memory area (physical memory area) having a start address at the physical address 10000h and an end address at the physical address 1FFFFh in the memory section 20 is allocated to the memory adaptor B, and relates this to a memory area (virtual memory area) having a start address at the virtual address 0000h and an end address at the virtual address FFFFh as its related virtual memory area. Furthermore, a memory area (physical memory area) having a start address at the physical address 20000h and an end address at the physical address 3FFFFh in the memory section 20 is allocated to the memory adaptor C, and relates this to a memory area (virtual memory area) having a start address at the virtual address 0000h and an end address at the virtual address 1FFFFh as its related virtual memory area.

For each of the computers 40, these virtual memory areas correspond (match) to memory addresses that are used for memory accesses within that computer 40. More specifically, when the computer 40 is started up, the memory share apparatus 10 notifies the computer 40 with the address (virtual address) of the virtual memory area according to an inquiry from the BIOS (Basic Input Output System) or the OS of the computer 40. Thus, the computer 40 recognizes the virtual memory area as the memory area for making memory accesses, and the computer 40 then carries out any memory access using this virtual address.

When the share management section 16 receives a memory access request (for example, read request or write request) that is accompanied by a memory address (virtual address) from the computer 40 via the memory adaptor 30, the share management section 16 is adapted to look up the above-described management table 12 on the basis of that virtual address, obtain (convert it into) the corresponding physical address, carry out any necessary memory operation to the physical memory area in the memory section 20, and return a result.

For example, in the example depicted in FIG. 3, in the computer 40-2 to which the memory adaptor B is attached, when the CPU of the computer 40-2 makes an access with a request, such as a read request or a write request, for example, to a certain memory area stating from a memory address (virtual address) of 0000h, a read request or a write request is executed at the certain memory area starting at a memory address (apparatus memory address) of 10000h in the memory section 20 in the apparatus main body 11.

As described above, the share management section 16 is adapted to make the storage apparatuses that are provided to the memory section 20, such as the memory cards 201 or the HDDs 202, function as an internal storage apparatus of the computer 40.

Although the above-described memory cards 201 and HDDs 202 are external storage apparatuses that are provided external to the computer 40, the memory share system 1 is adapted to make these external storage apparatuses to function as internal storage apparatuses of the computer 40.

In addition, the share management section 16 is also adapted to function as the size setting section that changes the size of memory areas allocated to each of the computers 40, and is adapted to set the size of the storage area allocated to the computer 40 in the memory section 20 to any value. For example, the share management section 16 is adapted to change the memory size allocated to each of the computers 40 on the basis of an instruction accompanied by the memory size after modification which is received from the user through management software of a management terminal 50 that will be described later or the user interface section 14, setting of dip switches in the setting section 34 in the memory adaptor 30.

In addition, the share management section 16 is adapted to monitor statuses, such as memory usage status at the memory section 20, the memory capacity mounted on the memory section 20, allocation status of the physical memory area in the memory array, and the status of physical memory. The share management section 16 is further adapted to display information indicating the statuses on the user interface section 14, the management terminal 50 that will be described later, or the like.

It is noted that the above-described management table 12 may be stored on the memory section 20 (first memory section 20a, second memory section 20b), or may be stored on another storage area provided to the memory share system 1, and many variations may be practiced without departing from the spirit of the present invention. The memory section 20 (first memory section 20a, second memory section 20b) or another storage area may function as the management table storage section that stores the management table 12.

In addition, the share management section 16 is adapted to enhance the reliability of storage areas in the memory section 20, such as setup of an RAID (Redundant Arrays of Inexpensive) configuration. It is noted that the RAID configuration of the memory may be set up and executed according to an input operation from, the user interface section 14 or the management terminal 50, for example, and set flexibly according to the configuration of the memory section 20 or the like. In addition, any RAID level from RAID 1 to RAID 6 may be practiced in order to tailor to the configuration of the memory section 20, the usage, and the like. It is noted that, for specific techniques to set up the RAID configuration, well-known techniques may be used in various manners and any detailed description thereof will be omitted.

The connection interface (I/F) 13 is an interface that communicatively connects each of the plurality of memory adaptors 30-1 to 30-4 to the share management section 16 via the communication lines 311, and is adapted to control communication between the share management section 16 and each of the memory adaptors 30-1 to 30-4. It is noted that the connection interface 13 is preferably configured according to the standard of the memory bus in the computer 40, and any detailed description thereof will be omitted.

It is noted that the connection interface 13 and the communication line 311 are configured to be attachable to and detachable from each other to enable the connection interface 13 and the communication line 311 to be connected to and disconnected from each other where necessary by the user, thereby improving convenience and increasing the versatility of the memory share system 1 and being highly convenient.

The user interface section 14 is configured to include a display apparatus and input keys (keyboard), for example, and is able to display a variety of pieces of information to be presented to the user on the display apparatus and enables the user to make a variety of operations and inputs through the input keys.

For example, the display apparatus of the user interface section 14 is adapted to display a variety of error messages or information indicating the status of the memory share apparatus 10. In addition, the user can enter or set the memory size allocated to each of the memory adaptors 30, or can see the status of the current value of the memory size using the input keys of the user interface section 14.

The external connection interface (I/F) 15 is an interface for communicatively connecting between the memory share apparatus 10 and the management terminal 50, and can be embodied using a variety of interface standards, such as a LAN (Local Area Network), a serial connection, the USB (Universal Serial Bus), for example.

The management terminal 50 is a terminal apparatus for managing the memory share apparatus 10, and is configured as a computer having an interface, such as, a LAN or a USB, for example. The management terminal 50 is communicatively connected to the external connection interface 15 of the memory share apparatus 10, and is adapted to set the size of a physical memory area (memory size) and addresses (physical address) allocated to each of the computers 40 for the memory section 20, and carried out management of usage or a health check.

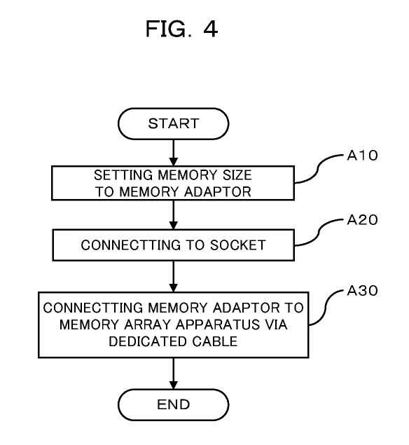

The processing when attaching the memory adaptor 30 to the computer 40 in the memory share system 1 as one embodiment that are configured as described above will be explained with reference to the flow chart (Steps A10-A30) depicted in FIG. 4.

The user sets as to whether the setting value on the apparatus main body 11 side or the setting value on the memory adaptor 30 side is to be used as the memory size allocated to a computer 40 using the dip switches or the like of the setting section 34 in the memory adaptor 30 (Step A10). Thereafter, the user inserts and connects its terminal 35 to the memory socket 41 provided on the mother board 42 of the computer 40 (Step A20), and then connects the memory adaptor 30 to the apparatus main body 11 via a communication line 311 (Step A30).

Thereby, attachment of the memory adaptor 30 to the computer 40 has been completed, and then the memory share system 1 is powered on and the memory share apparatus 10 is initialized.

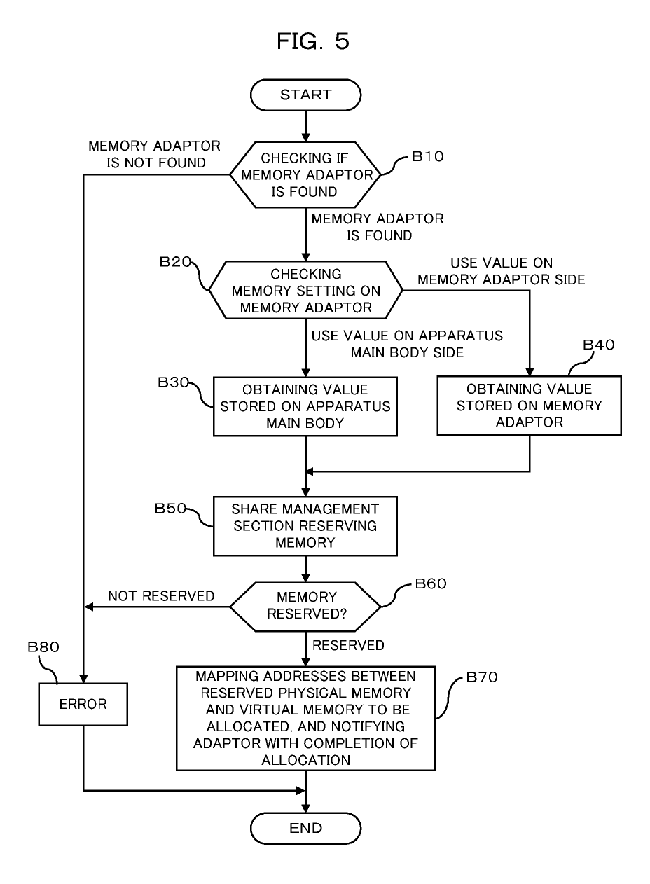

Next, the processing when initializing the memory share apparatus 10 in the memory share system 1 as one embodiment will be described with reference to the flow chart depicted in FIG. 5 (Steps B10-B80).

In the memory share apparatus 10, the share management section 16 checks whether or not the memory adaptor 30 is connected to the apparatus main body 11 and the memory adaptor 30 thereof is connected to the memory socket 41 of the computer 40 (Step B10). If the memory adaptor 30 is not connected to the apparatus main body 11 or the memory adaptor 30 is not connected to the memory socket 41 of the computer 40 (see the “MEMORY ADAPTOR IS NOT FOUND” route in Step B10), for example, the user is notified with an error notification by displaying the error on the user interface section 14(Step B80), and the processing is terminated.

In addition, if the memory adaptor 30 is connected to the apparatus main body 11 (see the “MEMORY ADAPTOR IS FOUND” route in Step B10), the share management section 16 checks the setting value of the setting section 34 in the memory adaptor 30 (Step B20), determines as to whether the setting value on the apparatus main body 11 side or the setting value on the memory adaptor 30 side is to be used, and, when the setting value on the memory adaptor 30 side is used, obtains setting value of the memory size.

When the setting value that has been set to the setting section 34 in the memory adaptor 30 indicates that the memory size set on the apparatus main body 11 side is to be used (see the “USE VALUE ON APPARATUS MAIN BODY” route in Step B20), the share management section 16 obtains the memory size (setting value) related to the computer 40 which is stored on the memory section 20 in the apparatus main body 11, for example (Step B30), and reserves a storage area having the obtained memory size to the computer 40 in the memory section 20 (Step B50).

In addition, when the setting value that has been set to the setting section 34 in the memory adaptor 30 indicates that the memory size set on the memory adaptor 30 side is to be used (see the “USE VALUE ON MEMORY ADAPTOR SIDE” route in Step B20), the share management section 16 obtains the memory size (setting value) related to the computer 40 which is stored on the setting section 34 in the memory adaptor 30 (Step B40), and the flow proceeds to Step B50.

The share management section 16 reserves a storage area (physical memory) corresponding to the obtained memory size for the computer 40 in the memory section 20. The share management section 16 checks whether or not an area of that memory size can be reserved in the memory section 20 (Step B60), and if the area is not reserved (see the “NOT RESERVED” route in Step B60), the flow proceeds to Step B80 in which the operator is notified with that error.

If a storage area corresponding to the obtained memory size can be reserved for the computer 40 in the memory section 20 (see the “reserved” route in Step B60), the share management section 16 allocates a virtual memory related to the reserved physical memory, maps the addresses of the physical memory area to the addresses of the virtual memory area in the management table 12, notifies the memory adaptor 30 with completion of the memory allocation (Step B70), and the processing is terminated.

With the above-described initialization processing in the memory share system 1, memory allocation or the like to each of the computers 40 is carried out, and the memory cards 201 and the HDDs 202 provided to the memory section 20 in the memory share apparatus 10 may become available as an internal storage apparatus (memory) of the computer 40.

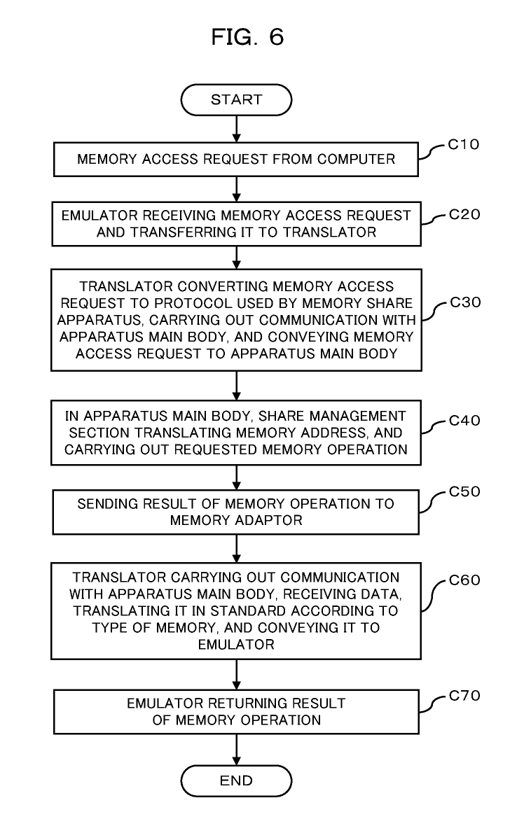

Next, the processing related to a memory access in the memory share system 1 as one embodiment of the present invention will be described with reference to the flow chart depicted in FIG. 6 (Steps C10-C70).

When a memory access request is carried out from the computer 40 (Step C10), in the memory adaptor 30, the emulator 33 receives that memory access request and transfers it to the translator 32 (Step C20).

The translator 32 converts the memory access request transferred from the emulator 33 according to the protocol used by the apparatus main body 11 (the memory share apparatus 10), carries out communication with the apparatus main body 11 through the interface 31, and conveys the converted memory access request to the apparatus main body 11 (Step C30). It is noted that the memory access request conveyed from the translator 32 to the apparatus main body 11 includes a memory address to be accessed.

In the apparatus main body 11 that receives the memory access request, the share management section 16 translates the memory address by looking up the management table 12, and carries out the request memory operation to the translated memory address (physical memory area) (Step C40).

More specifically, the share management section 16 translates the memory addresses by checking the connection interface 13, identifying the computer 40 (memory adaptor 30) that made the memory access request on the basis of the communication line 311 used for sending the memory access request, looking up the management table 12 using the memory address in the received memory access request as the virtual address, and obtaining the physical address related to that virtual address for the memory adaptor 30.

The share management section 16 then sends the result of the memory operation that is carried out (response signal) to the memory adaptor 30 (Step C50), in the memory adaptor 30, the translator 32 receives this response signal; thus communication between the apparatus main body 11 and the memory adaptor 30 is carried out (Step C60). The translator 32 converts the response signal to the format according to the protocol related to the memory in the computer 40, the emulator 33 sends the response signal (result of the memory operation) back to the computer 40 (e.g., CPU) (Step C70), and the processing is terminated.

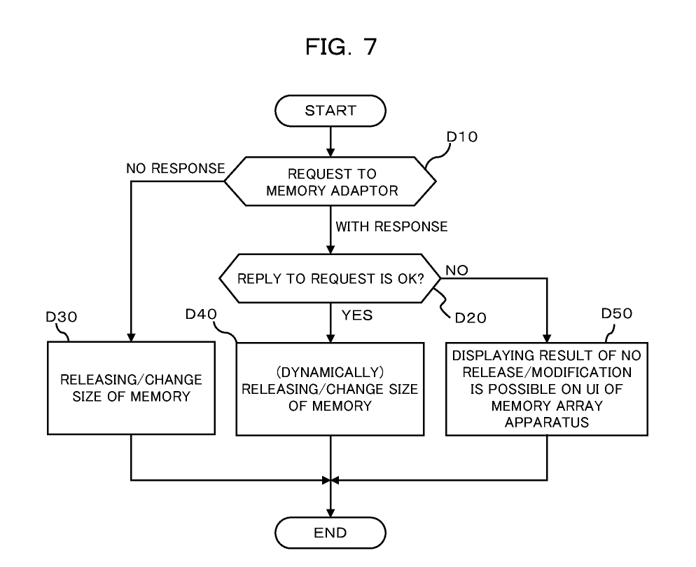

Next, the technique to release a memory or to change the memory size in the memory section 20 in the memory share system 1 as one embodiment will be described with reference to the flow chart depicted in FIG. 7 (Steps D10-D50).

Such release of the memory or modification of memory size is initiated by operations from the user interface section 14 or the management terminal 50, for example. When an instruction for releasing the memory or changing the memory size is received from the user interface section 14 or the management terminal 50, the share management section 16 sends a request to the memory adaptor 30 to see whether or not modification of the memory size is possible, and checks whether a response is received from the memory adaptor 30 (Step D10).

When no response is received from, the memory adaptor 30 (see the “NO RESPONSE” route in Step D10), the share management section 16 decides that the memory adaptor 30 is not connected, or the computer 40 is powered off. The share management section 16 changes the size of or releases of the memory allocated to the computer 40 according to the instruction from the user interface section 14 or the management terminal 50, modifies the management table 12 to reflect the status after the change (Step D30), and the processing is terminated.

When a response is received from the memory adaptor 30 (see the “WITH RESPONSE” route in Step D10), the share management section 16 then checks whether or not the reply from the memory adaptor 30 permits any modification of the memory size or the like (OK) (Step D20). The memory adaptor 30 checks the BIOS setting or the system setting of the computer 40, for example, to see of dynamic modification of the memory size is supported by the computer 40, and the availability or non-availability of dynamic modification of the memory size is replied (notified) to the share management section 16 via the communication line 311.

If a reply indicating that modification of the memory size is allowed is sent from the memory adaptor 30 (see the YES route in Step D20), processing, such as modification of the memory size is carried out (Step D40) and the processing is terminated even if the system of the computer 40 is running since the BIOS or the like in the computer 40 supports dynamic modification of the memory size.

On the other hand, a reply indicating that modification of the memory size is not allowed is sent from the memory adaptor 30 (see the No route in Step D20), the share management section 16 carries out control to display a message indicating that the modification of the memory size is not allowed or the memory cannot be released on the user interface section 14 (Step D50), and the processing is terminated.

For example, share management apparatus 16 may indicate the fact that the computer 40 does not support dynamic modification of the memory size by displaying a message “IN USE” or “NOT SUPPORTED” on the user interface section 14.

As described above, according to the memory share system 1 as one embodiment, in the in the memory share apparatus 10, by dividing storage areas of the memory cards 201 and the HDD 202 provided to the memory section 20a and allocating them to the plurality of the computers 40 as their internal storage apparatuses, it is possible to share the memory cards 201 and the HDD 202 provided to the memory section 20a as the internal storage apparatuses (main memory) among the plurality of the computers 40. Thus, it is possible to easily modify (flexibly adjust) the configuration of the internal storage apparatus, such as the memory size to be allocated, among the plurality of the computers 40, which is highly convenient.

In addition, addition and removal of the memory cards 201 and the HDDs 202 can be easily carried out by configuring the memory cards 201 and the HDDs 202 as being attachable or detachable in the memory section 20. Thus, it is possible to easily modify the configuration of the internal storage apparatuses of the computers 40, which is highly convenient.

Furthermore, the computers 40 are not required to have internal storage apparatuses since the memory cards 201 and the HDDs 202 provided to the memory section 20a are made to function as respective internal storage apparatuses of the plurality of the computers 40. Thus, it is possible to reduce the manufacturing cost.

In addition, in the memory share apparatus 10, by carrying out access management to the memory cards 201 and the HDDs 202 in the memory section 20 on the basis of a memory access request from a computer 40 which is obtained via the terminal 35 or the memory socket 41, it is possible to make the memory cards 201 and the HDDs 202 to function as the internal storage apparatus of the computer 40.

Furthermore, in the memory adaptor 30 of the memory share apparatus 10, the terminal 35 is configured to be capable of being attached to and detached from the memory socket 41 provided on the mother board 42 of the computer 40, and the share management section 16 carries out access management to the memory cards 201 and the HDDs 202 in the memory section 20 on the basis of an access request to the memory section 20 that is generated by the emulator 33 on the basis of a memory access request from the computer 40. Thus, any existing computer 40 having an internal memory section that is configured to be detachable to and from a storage apparatus can be used without any modification, which is highly convenient and cost-effective.

In addition, by converting, by the translator 32, between the protocol related to memory access requests in the computer 40 and the protocol in the memory section 20 in the memory share apparatus 10, it is possible to use storage apparatus employing a variety of protocols in the memory share apparatus 10, which is highly convenient and cost-effective.

Furthermore, in the memory section 20, by allocating, the share management section 16, storage areas for the computers 40 on the basis of an instruction accompanied by the memory size which is received from the management terminal 50 or the user interface section 14 as desired, or the memory size set to the memory adaptor 40, it is possible to easily modify the configuration of the internal storage apparatuses of the computers 40, which is highly convenient. In addition, it is possible to easily modify (flexibly adjust) the configuration of the internal storage apparatuses among the plurality of the computers 40, which is highly convenient.

The present invention is not limited to the embodiments described above, and various modifications may be made without departing from the spirit of the present invention.

For example, although the memory share system 1 is configured to include four the computers 40-1, 40-2, 40-3, and 40-4 in the above-described embodiment, this is not limiting and three or less computers 40 or five or more computers 40 may be provided.

In addition, although the memory section 20 is configured to include the memory cards 201 and the HDDs 202, such as SIMMs or DIMMs, in the above-described embodiment, this is not limiting, and a variety of storage apparatuses that can read and write information may be used.

Furthermore, although the computer 40 is adapted to include the memory socket 41 to which the memory adaptor 30 is attached in the above-described embodiment, this is not limiting. For example, the computer 40 may be configured such that the computer 40 have no memory cards mounted thereon and includes another interface in place of the memory socket 41, and that the memory share apparatus 10 and the interface are connected each other via a communication line. Thus, it is possible to directly send a memory access request from the CPU to the apparatus main body 11 (share management section 16), thereby reducing the manufacturing cost of the memory share apparatus 10.

As another interface provided to the computer 40 in place of the memory socket 41, a bus socket for establishing a bus connection may be used, for example.

In addition, although the translator 32 is adapted to function as a conversion section that converts between the protocol related to memory accesses in the computer 40 and the protocol related to memory accesses in the memory section 20 in the memory share apparatus 10 in the above-described embodiment, this is not limiting. Other element than the translator 32 may function as the conversion section. For example, the emulator 33 may have functionality as the conversion section, or a dedicated circuit that functions as the conversion section may be provided, many variations may be practiced without departing from the spirit of the present invention.

Transmission and reception of data between the apparatus main body 11 and the memory adaptor 30 may be carried out using a certain memory protocol for (for example, DIMM), or may be carried out using any specialized protocol.

When a specialized protocol is used for transmission and reception of data between the apparatus main body 11 and the memory adaptor 30, or a protocol other than the memory protocol used in the computer 40 to which the memory adaptor 30 is connected, protocol conversion by the translator 32 or the emulator 33 is required.

The protocol is not necessarily the same as the protocol for the memory cards 201 and the HDDs 202 mounted on the memory section 20 in the apparatus main body 11, and data accesses to the memory cards 201 or the HDDs 202 employed are carried out using respective access protocols in the share management section 16 in the apparatus main body 11.

The emulator 33, in response to a request for memory access or size information from the memory socket 41, emulates the protocol that conforms to the standards used in such request and return a response. It is noted that the response returned may be constructed according to the particular standard of the respective memory.

The embodiments include at least one of the following advantages:

(1) In the sharing apparatus that is configured to be capable of communicating with each of a plurality of information processing apparatuses and includes a storage device that is accessible from each CPU of the plurality of information processing apparatuses, by dividing storage areas of the storage apparatuses and allocating them to the plurality of information processing apparatuses as their internal storage apparatuses, it is possible to share the storage apparatuses as the internal storage apparatuses among the plurality of information processing apparatuses. Thus, it is possible to easily modify (flexibly adjust) the configuration of the internal storage apparatuses among these information processing apparatuses, which is highly convenient.

(2) Addition and removal of the storage apparatuses can be easily carried out by configuring the storage apparatuses as being attachable or detachable. Thus, it is possible to easily modify the configuration of the internal storage apparatuses of the information processing apparatuses, which is highly convenient.

(3) The information processing apparatuses are not required to have internal storage apparatuses since the storage apparatuses provided to the sharing apparatus are made to function as respective internal storage apparatuses of the plurality of information processing apparatuses. Thus, it is possible to reduce the manufacturing cost.

(4) By carrying out access management to the storage areas in the memory section on the basis of a memory access request from an information processing apparatus which is obtained via the connection section, it is possible to make the storage apparatuses to function as the internal storage apparatus of the information processing apparatus.

(5) In the sharing apparatus, the connection section is configured to be capable of being attached to and detached from the attachment section of an information processing apparatus, and the management section carries out access management to the storage area in the memory section on the basis of an access request to the memory section that is generated by the memory access mediating section on the basis of a memory access request from the information processing apparatus. Thus, any existing information processing apparatus having an internal memory section that is configured to be attachable to and detachable from a storage apparatus can be used without any modification, which is highly convenient and cost-effective.

(6) By converting between the protocol related to memory access requests in the information processing apparatus and the protocol in the memory section in the sharing apparatus, it is possible to use storage apparatus employing a variety of protocols, which is highly convenient and cost-effective.

(7) By allocating storage areas for information processing apparatuses on the basis of the size set by the share management section and the size setting section, it is possible to easily modify the configuration of the internal storage apparatuses of the information processing apparatuses, which is highly convenient. In addition, it is possible to easily modify (flexibly adjust) the configuration of the internal storage apparatuses among these information processing apparatuses, which is highly convenient.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments have been described in detail, it should be understood that the various changes, substitutions, and alterations could be made hereto without departing from the spirit and scope of the invention.

What is claimed is:

1. A memory share system comprising:
a plurality of information processing apparatuses; and
a sharing apparatus that is configured to be capable of communicating with each of the plurality of information processing apparatuses via a communication line, the sharing apparatus comprising:
a memory section that is configured to be capable of attaching and detaching a storage apparatus; and
a share management section that divides a storage area of the storage apparatus attached to the memory section and allocates the divided areas to each plurality of information processing apparatus, thereby enabling sharing of the storage apparatus by the plurality of information processing apparatuses, carries out a memory access to the storage area on the basis of a memory access request signal from the each information processing apparatus, and generates a response signal from the memory section, thereby allowing the storage apparatus to function as an internal storage apparatus of the information processing apparatus.

2. The memory share system according to claim 1, wherein
the information processing apparatus is configured to comprise an attachment section that is capable of being attached to and detached from the storage apparatus,
wherein the sharing apparatus comprises:
a connection section that is capable of being attached to the attachment section;
a memory access mediating section that obtains a memory access request signal in the information processing apparatus through the connection section that is attached to the attachment section in place of the storage apparatus, generates a memory access request signal to the memory section on the basis of the memory access signal, and generates a response signal to the information processing apparatus on the basis of a response signal from the memory section,
wherein the share management section carries out a memory access to the storage area on the basis of the memory access request signal generated by the memory access mediating section.

3. The memory share system according to claim 2, further comprising:
a conversion section that carries out a protocol conversion between a protocol related to the memory access in the information processing apparatus and a protocol related to a memory access in the memory section of the sharing apparatus.

4. The memory share system according to claim 1, wherein
the share management section sets a virtual storage area virtually accessible from the information processing apparatus, the virtual storage area corresponding to and having the same size as that of a storage area allocated to the information processing apparatus in a storage area of the storage apparatus,
wherein the sharing apparatus further comprises a management table storage section that stores, for each information processing apparatus, a management table that is organized by relating address information on the storage area, allocated by the share management section, to the each information processing apparatus in the storage area of the storage apparatus, to address information related to the virtual storage area.

5. The memory share system according to claim 1, further comprising:
a size setting section that is capable of arbitrarily setting the size of the storage area to be allocated to the information processing apparatus in the memory section,
wherein the share management section allocates the storage area to the information processing apparatus on the basis of the size set by the size setting section.

6. A sharing apparatus that is configured to be capable of communicating with a plurality of information processing apparatuses and each of the plurality of information processing apparatuses via communication lines, the sharing apparatus comprising:
a memory section that is configured to be capable of attaching and detaching a storage apparatus; and
a share management section that divides a storage area of the storage apparatus attached to the memory section and allocates the divided areas to each plurality of information processing apparatus, thereby enabling sharing of the storage apparatus by the plurality of information processing apparatuses, carries out a memory access to the storage area on the basis of a memory access request signal from the each information processing apparatus, and generates a response signal from the memory section, thereby allowing the storage apparatus to function as an internal storage apparatus of the information processing apparatus.

7. The memory share apparatus according to claim 6, further comprising:
a connection section that is capable of being attached to an attachment section that is formed to be capable of being attached to and detached from the storage apparatus in the information processing apparatus; and
a memory access mediating section that obtains a memory access request signal in the information processing apparatus through the connection section that is attached to the attachment section in place of the storage apparatus, generates a memory access request signal to the memory section on the basis of the memory access signal, and generates a response signal to the information processing apparatus on the basis of a response signal from the memory section,
wherein the share management section carries out a memory access to the storage area on the basis of the memory access request signal generated by the memory access mediating section.

8. The memory share apparatus according to claim 6, further comprising:
a conversion section that carries out a protocol conversion between a protocol related to the memory access in the information processing apparatus and a protocol related to a memory access in the memory section of the sharing apparatus.

9. The memory share apparatus according to claim 6, further comprising:
the share management section sets a virtual storage area virtually accessible from the information processing apparatus, the virtual storage area corresponding to and having the same size as that of a storage area allocated to the information processing apparatus in a storage area of the storage apparatus,
wherein the sharing apparatus further comprises a management table storage section that stores, for each information processing apparatus, a management table that is organized by relating address information on the storage area, allocated by the share management section, to the each information processing apparatus in the storage area of the storage apparatus, to address information related to the virtual storage area.

10. The memory share apparatus according to claim 6, further comprising:
a size setting section that is capable of arbitrarily setting the size of the storage area to be allocated to the information processing apparatus in the memory section,
wherein the share management section allocates the storage area to the information processing apparatus on the basis of the size set by the size setting section.
